(19) United States
(12) Patent Application Publication
(10) Pub. No.: US 2026/0334373 A1
(43) Pub. Date: Oct. 29, 2026

(54) ROUND BALER

(71) Applicant: Vermeer Manufacturing Company, Pella, IA (US)

(72) Inventors: Spencer Fynaardt, Pella, IA (US); Calvin Meinders, Pella, IA (US)

(21) Appl. No.: 19/099,677

(22) PCT Filed: Aug. 2, 2023
(86) PCT No.: PCT/US2023/071479

§ 371 Date: Jan. 29, 2025

Related U.S. Application Data
(60) Provisional application No. 63/370,203, filed on Aug. 2, 2022.

(51) Int. Cl. A01F 15/18; A01F 15/07

(52) U.S. Cl. CPC A01F 15/18; A01F 15/07; A01F 2015/077; A01F 2015/078; A01F 2015/186

(57) ABSTRACT

A round baler is disclosed including a crop feeding device, a lower throat roller, an upper throat roller, and one or more bale forming belts. The one or more bale forming belts include a first span that moves in a first direction to lift material away from the lower throat roller and a second span that moves in a second direction essentially opposite of the first direction. The second span moving in an opposite direction of the first span creates a belt convergence point where the material is caused to change direction. A first trajectory directs crop material toward a portion of the upper throat roller facing a bale formation chamber throughout formation of the bale, and a second trajectory directs excess crop material from the upper throat roller toward the bale formation chamber.

### CROSS REFERENCE TO RELATED APPLICATIONS

This application claims the benefit of priority to U.S. Provisional Patent Application No. 63/370203, filed Aug. 2, 2022, the contents and disclosure of which are incorporated by reference herein in their entirety.

### FIELD OF THE DISCLOSURE

The field of the disclosure relates a baling machine and, more particularly, to a variable diameter chamber round baler having a configuration of rollers and a bale forming belt that provides more consistent operation and that reduces crop discharge through the throat of the baling chamber.

### BACKGROUND

Round balers, machines that form bales of crop material into cylinders having a round cross-section, were initially capable of forming bales having a dimensions of approximately twenty-four inches in diameter and approximately forty-eight inches in length. The formed bales weighed between fifty and one hundred pounds, and could be lifted and moved manually. In late 1960s and early 1970s round balers were developed to form much larger cylindrical bales, some with a diameter of approximately seventy-two inches and sixty inches in length. These bales had to be lifted and moved with machinery. The basic mechanisms used to form the small and large round bales were significantly different. The differences were required to meet the specific bale formation challenges associated with forming the larger dimensioned bales. Specific aspects of the large dimension bale formation process that required changes to the smaller bale formation mechanism included:
1) formation of a bale core: this step in the formation process occurs when crop material first enters the bale chamber where the crop needs to start rolling in a circular manner to form a bale core; and
2) bale growth: this phase or step in the bale formation process involves an increase in the size of the bale from the core, to the final bale size. With variable chamber balers various mechanisms move to allow the bale to grow in size, while compression force is maintained to ensure the bale possesses the desired bale density and while the movement of the crop material is controlled to prevent it from escaping.

U.S. Pat. No. 3,722,197 is one of the earliest patents describing a large round baler. This patent describes a gate assembly comprising curved finger members that extend over, and close a space between, rollers to preclude the crop material from traveling between rollers while the bale core is being formed. The baler forms a bale core by the combined action of belts, rollers and the gate assembly. As described in U.S. Pat. No. 3,722,197 it was critical to control the tendency for the crop material to travel along with the bale forming belts, and between rollers during formation of the bale core. In this patent, the undesirable travel of the crop with the bale forming belts was solved by the introduction of a relatively complex mechanism, the gate assembly, that was withdrawn from between the belts as the bale size increased.

Arrangements of bale forming belts and rollers, without similar gate assemblies, have been previously developed. As an example, FIGS. 1-5 illustrate one design of a baler 100. This arrangement includes a crop pickup 102, a crop feeding device 104 that moves the crop material through a crop inlet throat 106 to a bale forming chamber defined by a lower throat roller 110, bale forming belts 120, front belt roller 130 and upper throat rollers 140, 142. In this arrangement, with the bale chamber empty, as illustrated in FIG. 1, the lower roller 110 rotates clockwise which propels the incoming crop material backwards, towards crop feeding device 104 and into contact with the bale forming belts 120. The belts proximate inlet throat 106 move upwards, from where they are in contact with the lower roller 110, towards the front belt roller 130. Before reaching roller 130, the belts contact the upper throat roller 140, that is rotating in a clockwise direction. The surface of the upper throat roller 140 moves in the opposite direction of the direction of movement of the bale forming belts 130. As the incoming material is moved backward by the lower roller 110 it is forced into contact with the bale forming belts 120 that propel the crop material generally upwards, and into contact with the upper throat roller 140 which propels the crop material towards the crop inlet 106 and lower throat roller 110. This generally circular path of motion by the crop material causes a bale core to form. Key aspects or enablers of the bale core formation include the position of the upper throat roller 140, where it is in contact with the bale forming belts 120, and the fact that the surface of the upper throat roller 140 is moving in a direction that is opposite the direction of movement of the bale forming belts. The difference is direction of relative motion serves to strip the crop material away from the bale forming belts as the bale core starts to form.

FIGS. 2-5 illustrate an aspect of this arrangement that occurs as the bale grows, including variation in the trajectory of the crop material at the point where the bale forming belts contact the front belt roller 130, illustrated as arrow 150. FIG. 2 illustrates the trajectory at the bale start. As noted above, the crop material is stripped away from the belts by the upper throat roller in this configuration, so the crop material does not follow that trajectory.

FIG. 3 illustrates the configuration with a small bale, where the crop trajectory is between front belt roller 130 and the upper throat roller 140. There is a small gap between these rollers, required to reduce the potential for belt damage that can occur if stray crop material gets between the bale forming belt and the front belt roller 130. Thus, in this configuration there is a potential for crop material to be propelled through this gap, rather than moving downward, following the belt path into the bale forming chamber. The gap allows for crop material to undesirably exit the baler. The stray crop material is discharged from the baler, and therefore, is not integrated into the bale. This in fact can create a performance challenge in some crop conditions. In FIG. 3, trajectory 150 is tangential to roller 130 and the exterior surface of the bale.

FIGS. 4 and 5 illustrate this arrangement with larger bales, illustrating that the crop trajectory 150 changes as the bale grows. As the bale grows, the crop trajectory 150 changes, (compare direction of arrow 150 between FIGS. 4 and 5) such that the trajectory directs the crop material into contact with the upper throat roller 140, reducing the likelihood of crop material to be undesirably discharged from the baler. The tendency for the crop to be propelled through the gap between the front belt roller 130 and the upper throat roller 140 occurs only when the forming bale is a certain size.

FIGS. 6-10 illustrate another design of a baler 200. This arrangement includes a crop pickup 202, a crop feeding device 204 that moves the crop material through a crop inlet throat 206 to a bale forming chamber defined by a lower roller 210, bale forming belts 220, front belt roller 230 and upper throat roller 240. In this arrangement, the bale forming belts are routed around various rollers such that the starting bale forming chamber includes a rear vertical belt span 222 and a front belt span 224. The incoming crop material is propelled backwards by the crop feeding device 204 into contact with lower roller 210 that is rotating clockwise and the rear vertical belt span 222 that is moving upwards. The crop material is propelled upwards, by the rear belt span 222, towards the front belt span 224, and is forced to change direction at a belt convergence point 226, where the two belt spans are close to one another. The crop material starts to follow a circular path of motion to form a bale core at this point, and follows the front belt span 224 towards, and into contact with the upper throat roller 240 that is rotating clockwise and that maintains the crop material within the bale forming chamber to and along the circular path of motion.

FIGS. 7-10 illustrate an aspect of this arrangement that occurs as the bale grows in size including a variation in the trajectory 250 of the crop material at the point where the bale forming belts contact the front belt roller 230. FIG. 7 illustrates the trajectory 250 at the bale start. With this arrangement the crop material is forced to change direction, and start to move in a circular path, by the differential direction of the rear belt span 222 and the front belt span 224. However, there is a potential for crop material to follow this trajectory 250 at the crop start, and to undesirably exit the baler through the gap between the front belt roller 230 and the upper throat roller 240. FIGS. 8-10 illustrate how this trajectory 250 changes as the bale size changes. Similar to trajectory 150 as described above, at certain stages, trajectory 250 is tangential to roller 130 and the exterior surface of the bale, as seen in FIG. 8. There is potential for crop to be discharged from the bale chamber during the early portions of the bale formation process. In some crop conditions stray crop material is undesirably discharged from the bale formation chamber, limiting performance.

The arrangements illustrated in FIGS. 1-5 and in FIGS. 6-10 are characterized by poor performance in some crop conditions. There is a need for an improved baler arrangement to provide improved operation in a wider variety of crop conditions.

### SUMMARY

In one embodiment, a round baler is disclosed. The round baler includes a crop feeding device, a lower throat roller, wherein the crop feeding device directs material to the lower throat roller, an upper throat roller, and one or more bale forming belts. The one or more bale forming belts include a first span that moves in a first direction to lift material away from the lower throat roller and a second span that moves in a second direction essentially opposite of the first direction. The second span moving in an opposite direction of the first span creates a belt convergence point where the material is caused to change direction. A first trajectory directs crop material toward a portion of the upper throat roller facing a bale formation chamber throughout formation of the bale, and a second trajectory directs excess crop material from the upper throat roller toward the bale formation chamber.

In another embodiment, a baling system for baling crop material is disclosed. The baling system includes one or more bale forming belts including a first span that moves in a first direction to lift material away from a lower throat roller and a second span that moves in a second direction essentially opposite of the first direction. The second span moving in an opposite direction of the first span creates a belt convergence point where the material is caused to change direction. Further, the baling system includes one or more rollers, wherein one of the rollers is an upper throat roller, a bale formation chamber being defined in part by the one or more bale-forming belts and the one or more rollers, and a crop feeding device configured to direct material towards the bale formation chamber. A first trajectory directs the crop material toward a portion of the upper throat roller facing the bale forming chamber throughout the formation of the bale and a second trajectory directs excess crop material from the upper throat roller toward the bale formation chamber.

In yet another embodiment, a round baler is disclosed. The round baler includes a crop feeding device, a lower throat roller, wherein the crop feeding device directs material to the lower throat roller, an upper throat roller, and one or more bale forming belts. The one or more bale forming belts include a first span that moves in a first direction to lift material away from the lower throat roller and a second span that moves in a second direction essentially opposite of the first direction. A gap is formed between the second span and the upper throat roller, and a first trajectory directs crop material away from the gap.

### BRIEF DESCRIPTION OF THE DRAWINGS

FIG. 1 is a cross-section side view of a first prior art baler without a bale in the bale forming chamber;

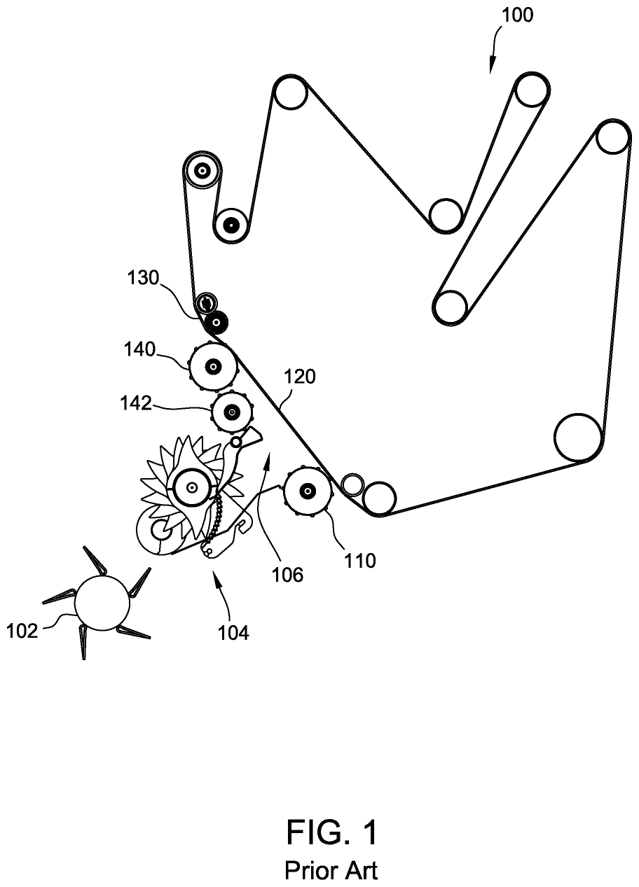

FIG. 2 is a cross-section side view of the first prior art baler without a bale in the bale forming chamber showing a crop trajectory;

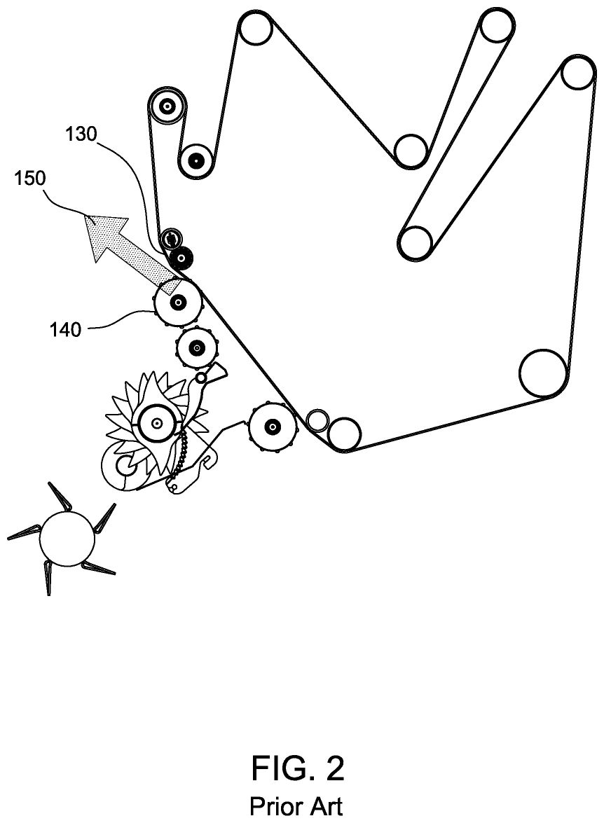

FIG. 3 is a cross-section side view of the first prior art baler with a bale of a first size in the bale forming chamber showing a crop trajectory;

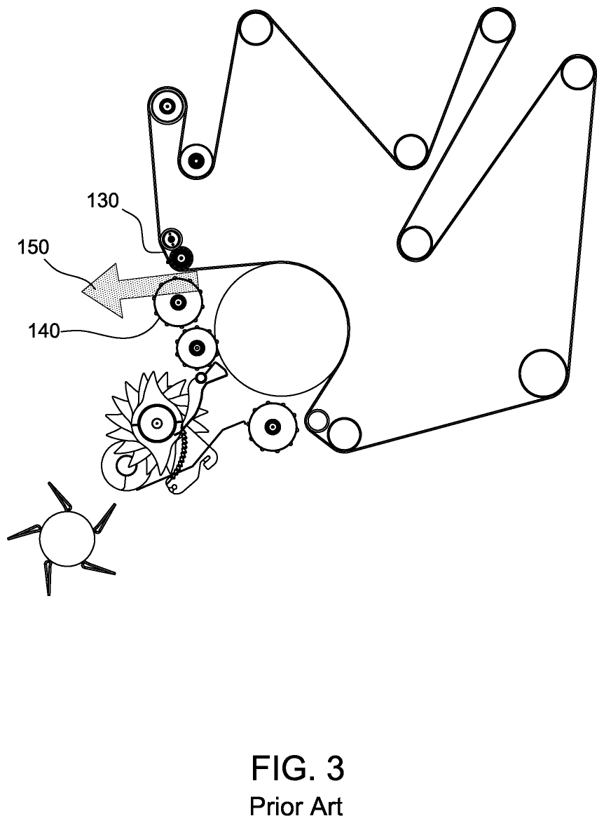

FIG. 4 is a cross-section side view of the first prior art baler with a bale of a second size in the bale forming chamber showing a crop trajectory;

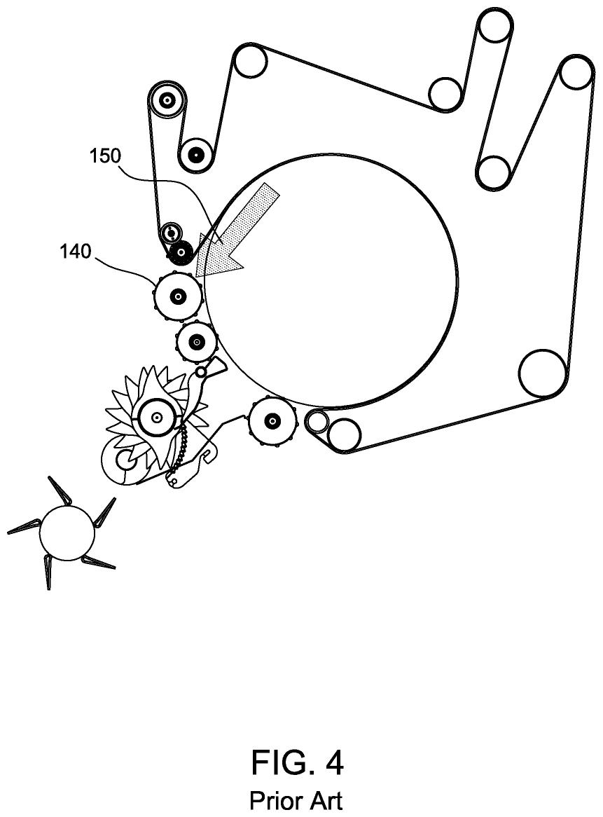

FIG. 5 is a cross-section side view of the first prior art baler with a bale of a third size in the bale forming chamber showing a crop trajectory;

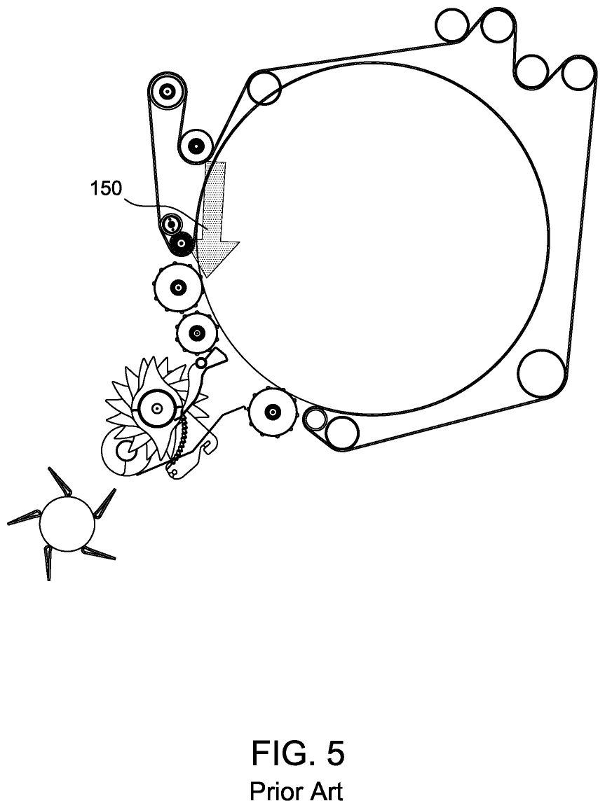

FIG. 6 is a cross-section side view of a second prior art baler without a bale in the bale forming chamber;

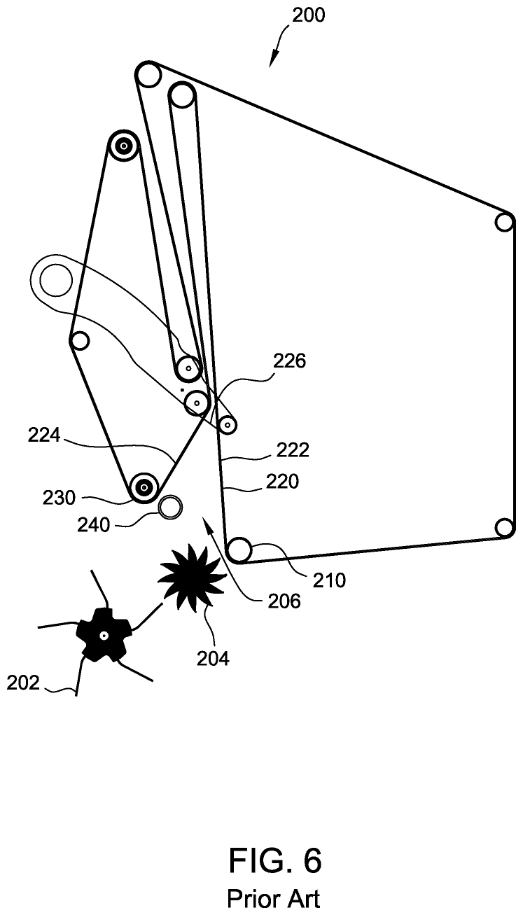

FIG. 7 is a cross-section side view of the second prior art baler without a bale in the bale forming chamber showing a crop trajectory;

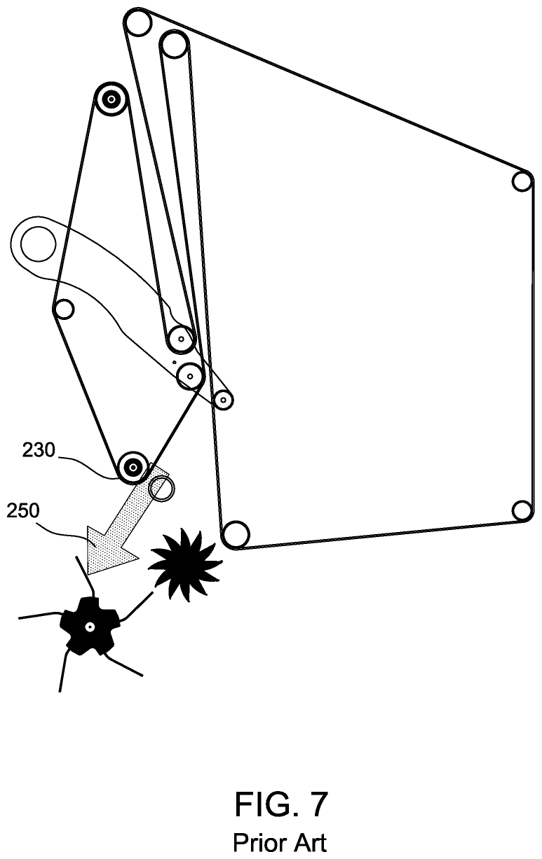

FIG. 8 is a cross-section side view of the second prior art baler with a bale of a first size in the bale forming chamber showing a crop trajectory;

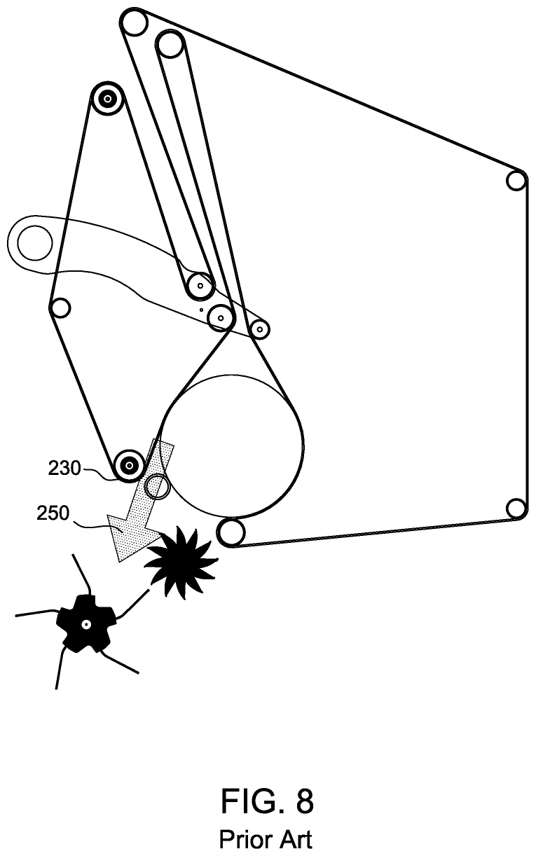

FIG. 9 is a cross-section side view of the second prior art baler with a bale of a second size in the bale forming chamber showing a crop trajectory;

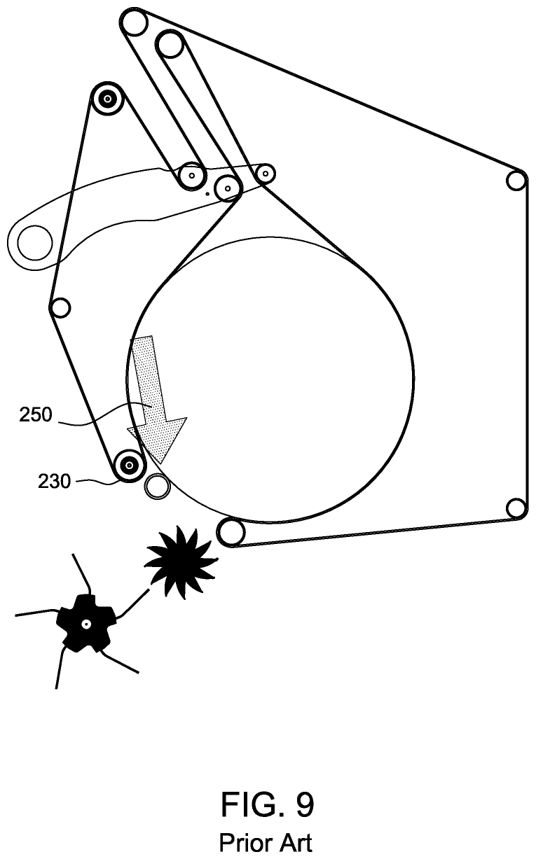

FIG. 10 is a cross-section side view of the second prior art baler with a bale of a third size in the bale forming chamber showing a crop trajectory;

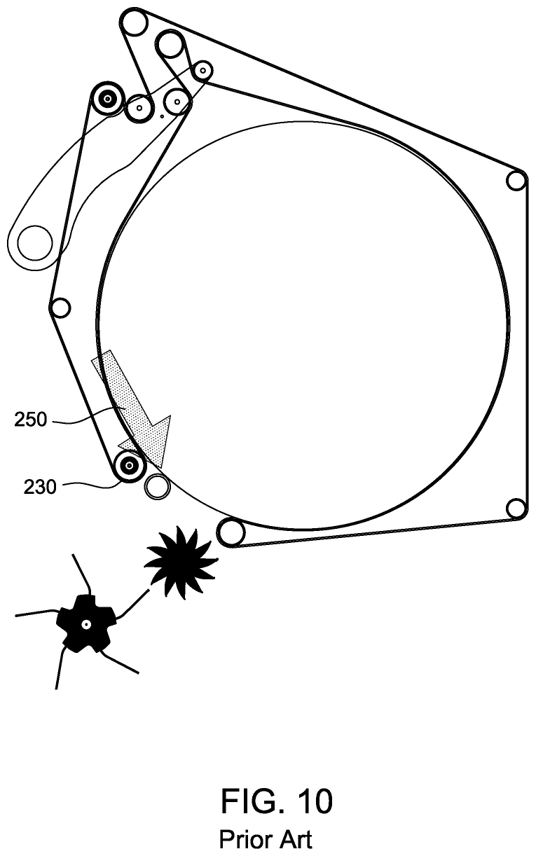

FIG. 11 is a perspective view of a round baler of the present disclosure;

FIG. 12 is a perspective view of the round baler of FIG. 11 with side panels removed;

FIG. 13 is a cross section side view of the round baler of FIG. 11;

FIG. 14 is a cross-section side view of a round baler of the present disclosure;

FIG. 15 is a cross-section side view of the bale starting chamber of the round baler of FIG. 14;

FIG. 16 is a cross-section side view of the round baler of FIG. 14 without a bale in the bale forming chamber showing a crop trajectory;

FIG. 17 is a cross-section side view of the round baler of FIG. 14 with a bale of a first size in the bale forming chamber showing a crop trajectory;

FIG. 18 is a cross-section side view of the round baler of FIG. 14 with a bale of a second size in the bale forming chamber showing a crop trajectory;

FIG. 19 is a cross-section side view of the round baler of FIG. 14 with a bale of a third size in the bale forming chamber showing a crop trajectory;

FIG. 20 is a cross-section side view of another embodiment of a round baler of the present disclosure;

FIG. 21 is a cross-section side view of the bale starting chamber of the round baler of FIG. 20.

FIG. 22 is a cross-section side view of the round baler of FIG. 20 without a bale in the bale forming chamber showing a crop trajectory;

FIG. 23 is a cross-section side view of the round baler of FIG. 20 with a bale of a first size in the bale forming chamber showing a crop trajectory;

FIG. 24 is a cross-section side view of the round baler of FIG. 20 with a bale of a second size in the bale forming chamber showing a crop trajectory;

FIG. 25 is a cross-section side view of the round baler of FIG. 20 with a bale of a third size in the bale forming chamber showing a crop trajectory; and

Corresponding reference characters indicate corresponding parts throughout the drawings.

### DETAILED DESCRIPTION

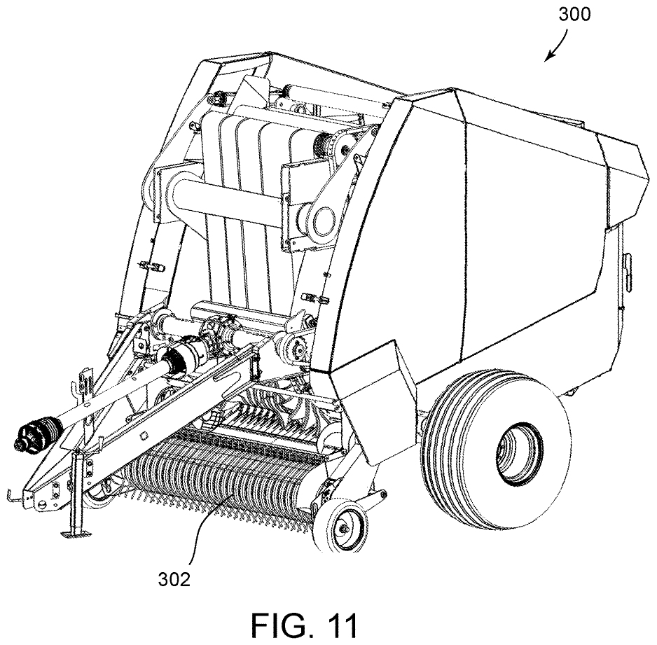

FIG. 11 illustrates a perspective view of a round baler 300. The round baler 300 includes a crop pickup 302.

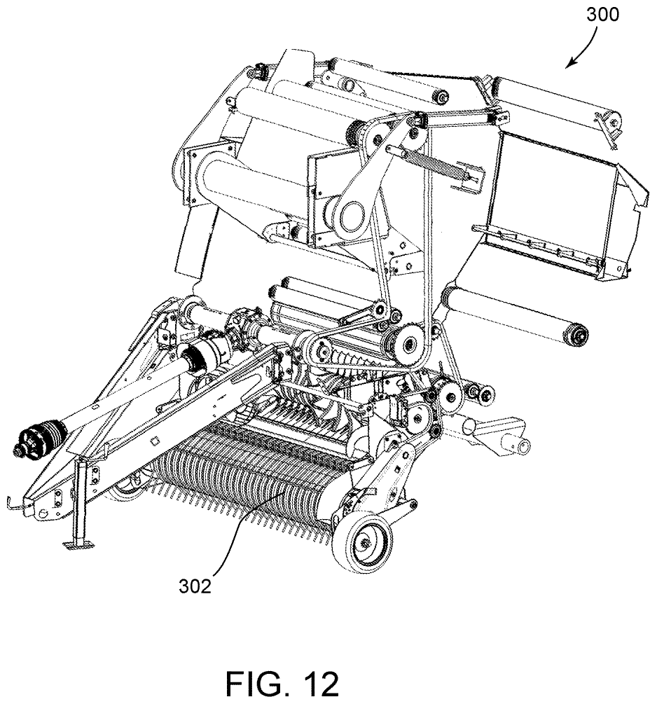

FIG. 12 depicts the round baler 300 with the side panels removed to reveal the interior mechanisms of the baler 300.

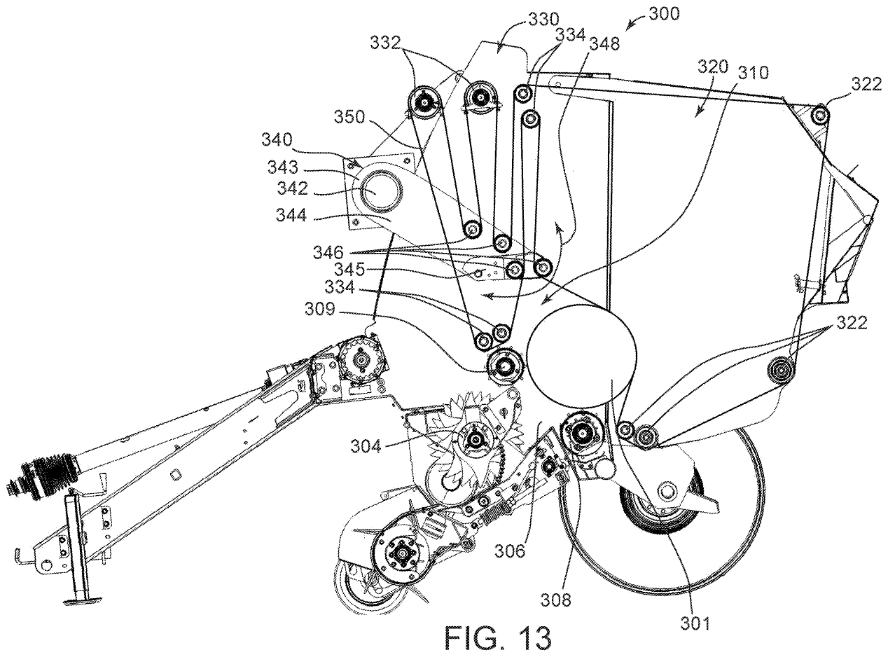

FIG. 13 depicts a side view of the round baler 300 including a crop feeding device 304 (e.g., rotor which may include a chopper) that moves material to a variable-size bale forming chamber 310 (or more simply “bale forming chamber”). The round baler 300 further includes a crop inlet throat 306, a lower throat roller 308, an upper throat roller 309, a tailgate region 320, a front frame region 330, and a belt tightener 340. The tailgate region further includes a plurality of tailgate rollers 322. The front frame region further includes plurality of drive rollers 332, which are driven by a drive system, and a plurality of idler rollers 334, which passively rotate. The belt tightener 340 pivots about a pivot point 342 and further includes a tightener arm 344 and a plurality of belt tightener rollers 346. A continuous bale forming belt 350 is positioned around the tailgate rollers 322, the drive rollers 332, the idler rollers 334, and the belt tightener rollers 346. The belt 350 may be a wide single belt (nearly the width of the bale chamber) or any number of belts in parallel.

In the exemplary embodiment, the tailgate rollers 322 are positioned about the perimeter of the tailgate region 320 and are essentially stationary. The drive rollers 332 and the idler rollers 334 are positioned about the front frame region 330 are also essentially stationary.

The pivot point 342 is located at a first end 343 of the tightener arm 344, and the belt tightener rollers 346 are located at a second end 345 of the tightener arm 344. The tightener arm 344 pivots about the pivot point 342, moving the belt tightener rollers 346 along an arcuate path identified by arrows 348. The movement of the tightener arm 344 moves belt tightener rollers 346 along the arcuate path 348, allows for adjustment of the tension on the belt 350, and allows for adjustment in length of certain spans of belt 350. As the volume of bale 301 increases, the belt tighter 340 is adjusted by moving the position of the tightener arm 344 to adjust belt 350 to accommodate the changing volume of the bale 301. In the present embodiment, the round baler 300 includes one belt tightener, but other embodiments may include any suitable number of belt tighteners.

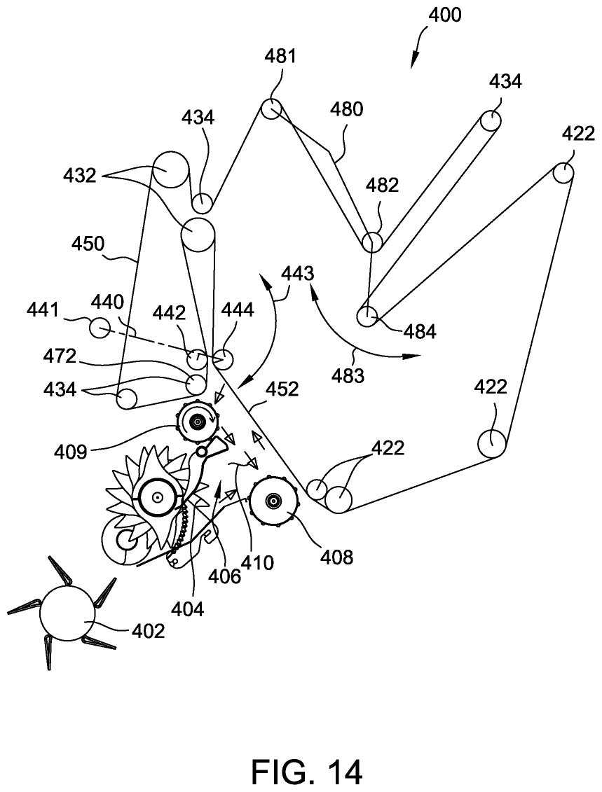

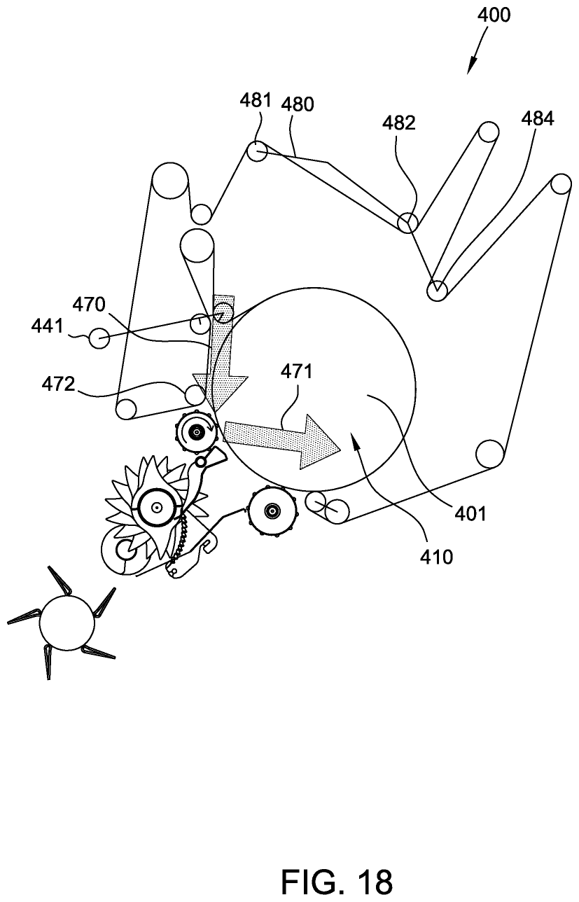

FIGS. 14-19 depict another embodiment of a round baler 400 for producing a bale 401. Round baler 400 is substantially similar to round baler 300, except that round baler 400 further includes a second belt tightener 480.

Similar to round baler 300, round baler 400 includes a crop pickup 402, a crop feeding device 404, a bale forming chamber 410, a crop inlet throat 406, a lower throat roller 408, and an upper throat roller 409. Round baler 400 further includes a plurality of tailgate rollers 422, a plurality of drive rollers 432, a plurality of idler rollers 434, and a first belt tightener 440 which rotates about a pivot point 441 and moves along an arcuate path identified by arrows 443. Baler 400 further includes a second belt tightener 480, which rotates about a pivot point 481 and moves along an arcuate path identified by arrow 483. The second belt tightener 480 includes rollers 482, 484. A continuous bale forming belt 450 is positioned around, and supported by, the tailgate rollers 422, the drive rollers 432, the idler rollers 434, and the belt tightener rollers 442, 444, 482, 484.

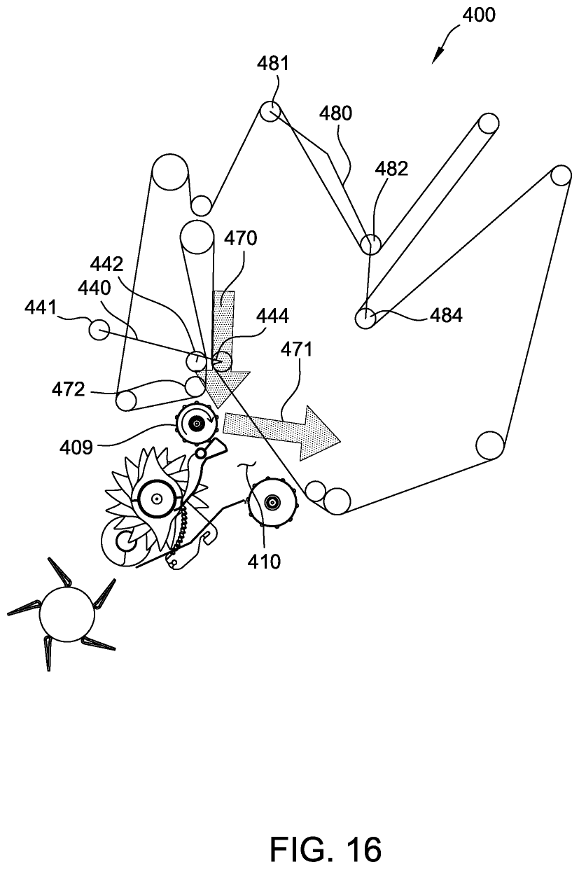

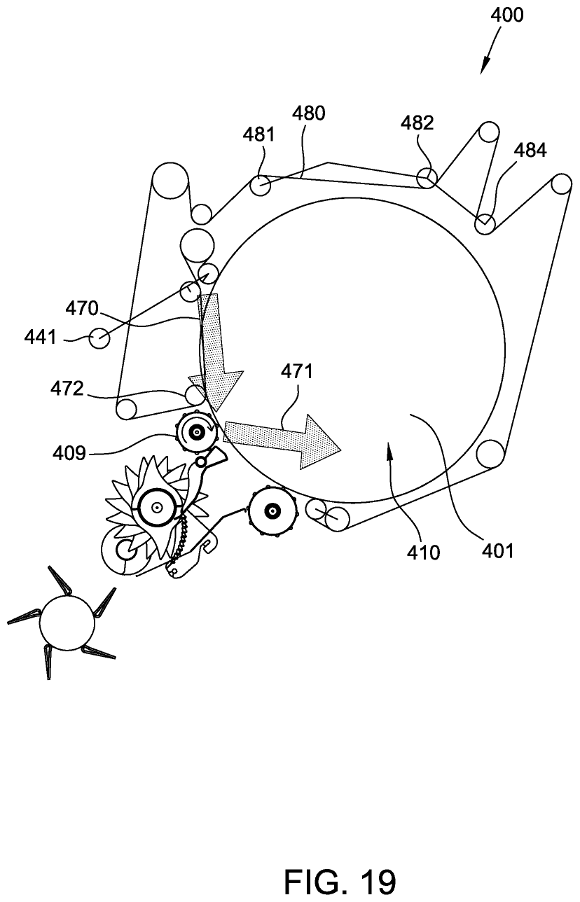

Crop material enters the bale-forming chamber 410 through the crop inlet throat 406 that is defined between the lower throat roller 408 and the upper throat roller 409. The bale forming chamber 410 is defined by the lower throat roller 408, belt 450, and the upper throat roller 409. The bale forming chamber 410 is extendable from a starting bale forming chamber (i.e., the chamber before addition of crop material) as shown in FIG. 16 to a maximum bale forming chamber (i.e., full chamber extension with a maximum diameter bale being present) shown in FIG. 19 as the bale volume grows in magnitude.

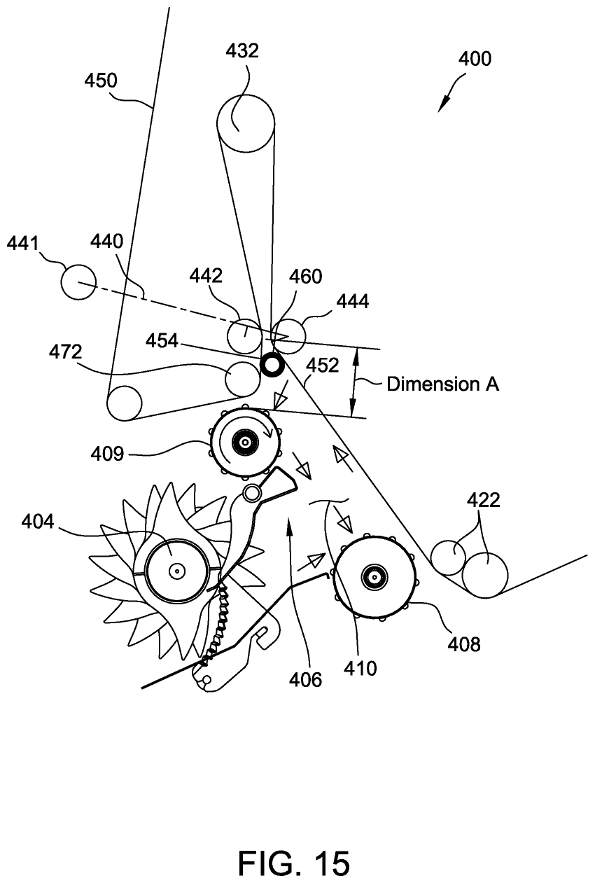

The starting bale forming chamber is shown in FIGS. 14 and 15. The continuous belt 450 is routed around and supported by various belt rollers, including tailgate rollers 422, drive rollers 432, idler rollers 434, and belt tightener rollers 442, 444, such that the starting bale forming chamber is defined by a rear belt span 452 and a front belt span 454.

During operation, incoming crop material is propelled backwards towards crop inlet throat 406 by the crop feeding device 404 into contact with the lower throat roller 408 that is rotating clockwise and the rear belt span 452 that is moving upwards. The crop material is propelled upwards, by the rear belt span 452, towards the front belt span 454. The crop material is forced to change direction at a belt convergence point 460, shown in FIG. 15, where the two belt spans 452, 454 are sufficiently close to one another (e.g., less than one inch apart) to cause the crop material to be re-directed downward. (The crop material starts rolling in a circular manner to form a bale core in the bale forming chamber 410 by following the front belt span 454 downward and into contact with the upper throat roller 409 that is rotating clockwise. The upper throat roller 409 redirects the crop material such that it remains in the bale forming chamber 410 to continue this circular movement.

The round baler 400 includes features which improve consistency when forming the bale core. The distance between the upper throat roller 409 and the belt convergence point 460 (“Dimension A” in FIG. 15) influences the initial rolling action of the crop material as it forms the bale core. In some embodiments, this distance is less than 15 inches or, as in other embodiments, less than 10 inches, between 5 and 10 inches, or between 8 and 10 inches.

FIGS. 16-19 illustrate the round baler 400 as the bale 401 volume is increasing, and include a variation in a first trajectory 470 of the crop material (and the belt) along the front belt span 454 toward the upper throat roller 409 (e.g., at the point where the belt 450 wraps around a front belt roller 472). Trajectory 470 differs from trajectories 150, 250 described above. The arrangement of rollers in round baler 400 produces trajectory 470 which is directed substantially vertically downward toward crop inlet throat 406, along the portion of upper throat roller 409 facing the chamber 410. The trajectory 470 remains consistently oriented downward throughout operation of baler 400 and growth in volume of the round bale. The arrangement of rollers prevents trajectory 470 from being aimed towards the gap defined between front belt roller 472 and upper throat roller 409, thereby preventing undesirable discharge of stray crop material from baler 400. The crop material is directed from the upper throat roller 409 in the direction of a second trajectory 471 which is generally in the direction of the bale forming chamber 410. The direction of trajectory 471 is influenced, in part, by the clockwise rotation of the upper throat roller 409. As crop material is fed into the bale forming chamber 410, the bale 401 grows in volume, resulting in additional span of belt 450 that contacts the outer periphery of the bale 401. The length of the belt 450 along the bale periphery is available as a result of movement of the first belt tightener 440, which includes rollers 442, 444, and the second belt tightener 480, including rollers 482, 484. As one or both of these belt tighteners 440, 480 rotate, the spans of belt 450 between the rollers mounted to the belt tighteners 440, 480 and the other rollers mounted to the baler 400, change in length. These belt spans get smaller to provide the length of belt at the perimeter of the forming bale 401.

The roller 442 that is mounted to the first belt tightener 440 defines the direction of the belt trajectory 470. The first belt tightener 440, with the roller 442, is positioned such that as the first belt tightener 440 rotates, the roller 442 moves along a path that maintains approximately the same trajectory 470 regardless of the volume of the bale (i.e., as the bale forming chamber transitions from the starting bale forming chamber to the maximum bale forming chamber). Because trajectory 470 is directed toward upper throat roller 409 and trajectory 41 is directed towards the bale forming chamber 410, any crop which is not yet integrated into the bale 401 is prevented from being discharged out of the round baler 401. Rather, the clockwise motion of the upper throat roller 409 directs any excess crop back into the bale forming chamber 410.

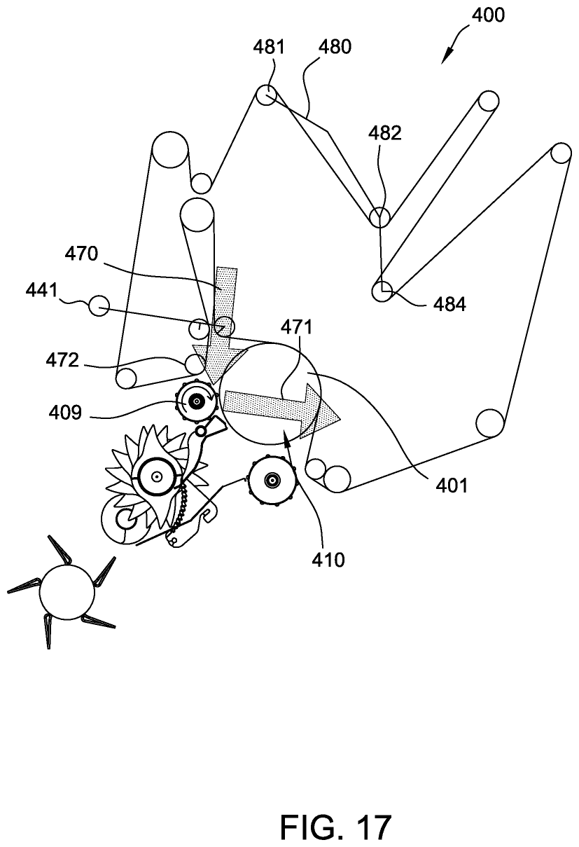

FIG. 16 illustrates the trajectory 470 at the bale start, where it is directed towards the upper throat roller 409. As shown in FIGS. 17-19, the trajectory 470 (of the belt and crop material) is directed towards the upper throat roller 409 at all times, regardless of the bale volume (i.e., a line coincident with the trajectory 470 intercepts the upper throat roller 409). By directing material to the upper throat roller 409 throughout bale formation, the potential for crop material to escape the bale formation chamber is reduced or even prevented, as any material following the trajectory 470 will contact the upper throat roller 409 which will deflect that material toward the bale chamber 410 and away from the crop inlet throat 406.

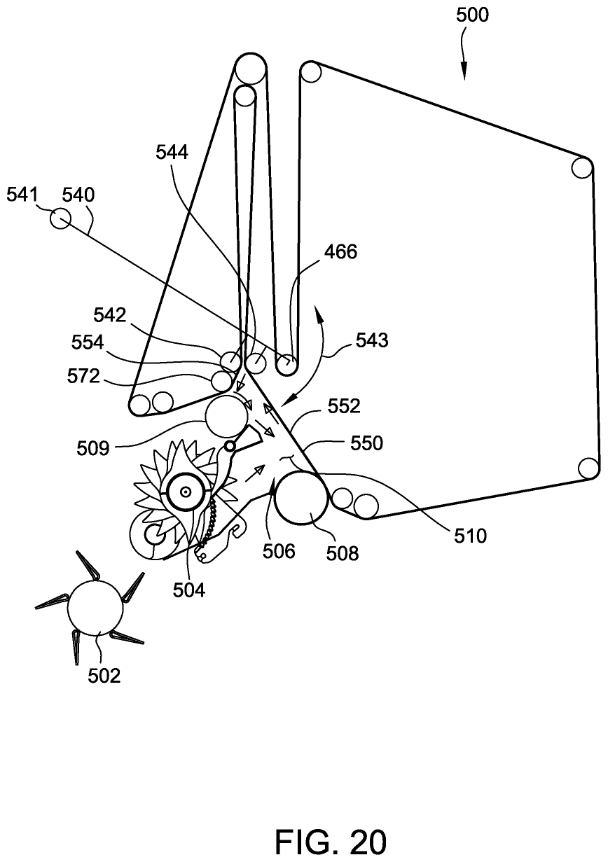

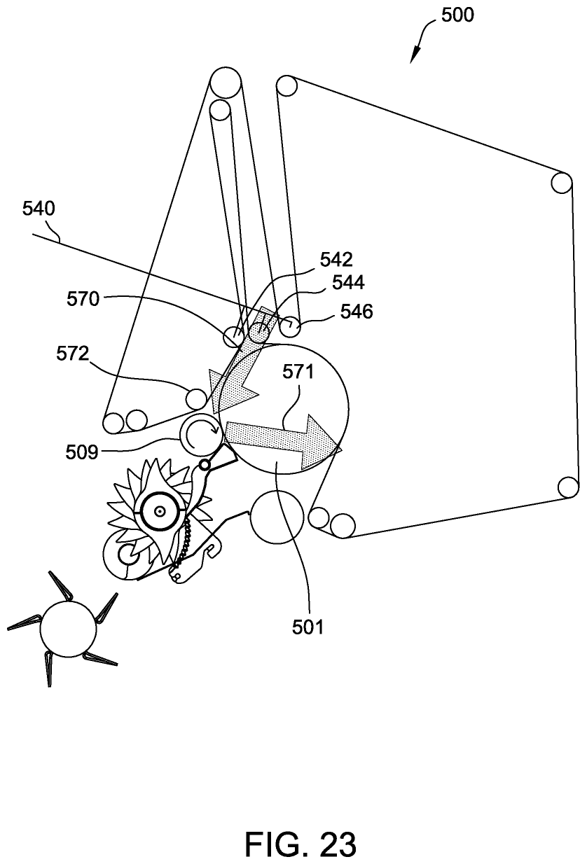

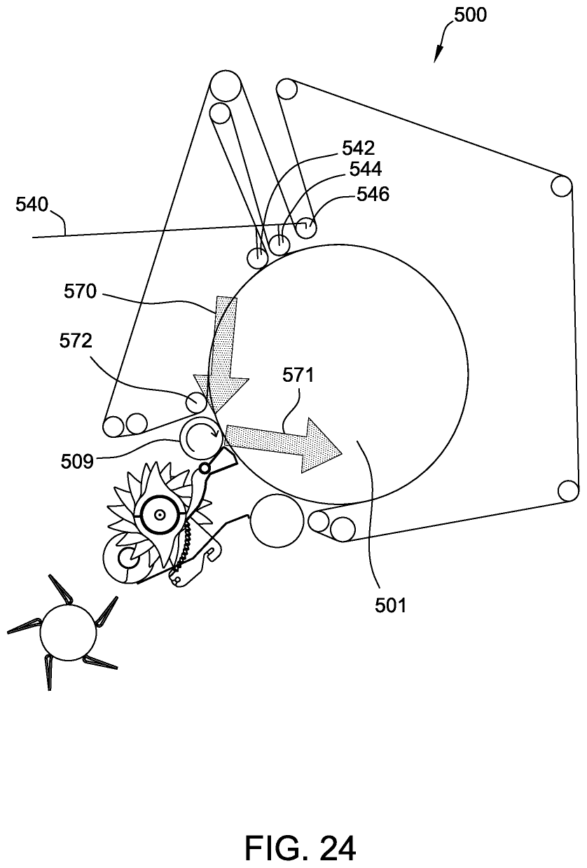

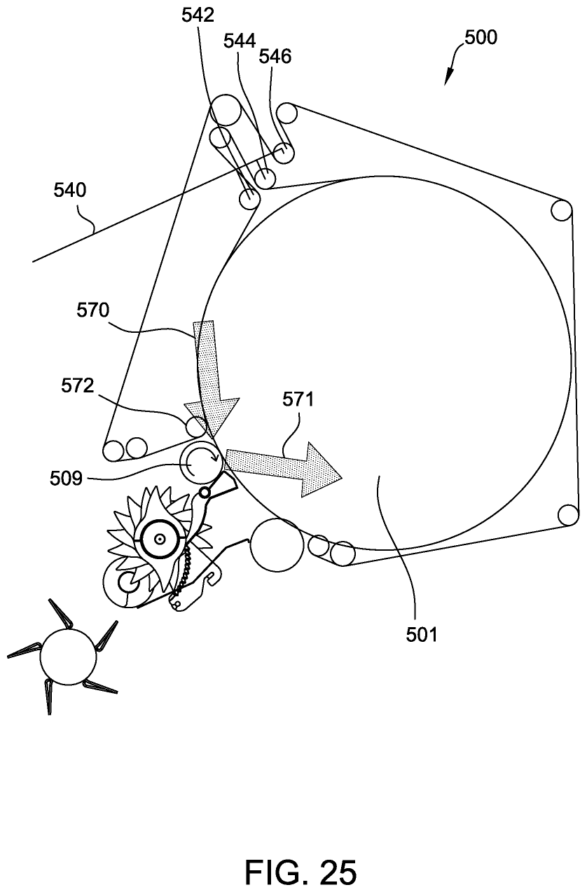

FIGS. 20-25 illustrate another embodiment of a round baler 500 for producing a bale 501 including a single belt tightener 540. Similar to balers 300 and 400 described above, baler 500 has a crop pickup 502, a crop feeding device 504 that moves material to a variable-size bale forming chamber 510, and a crop inlet throat 506. Baler 500 also includes a crop inlet throat 506, a lower throat roller 508, and an upper throat roller 509. Belt tightener 540 rotates about a pivot point 541 and moves along an arc path 543 and includes belt tightener rollers 542, 544, 546. A belt 550 is positioned around the rollers.

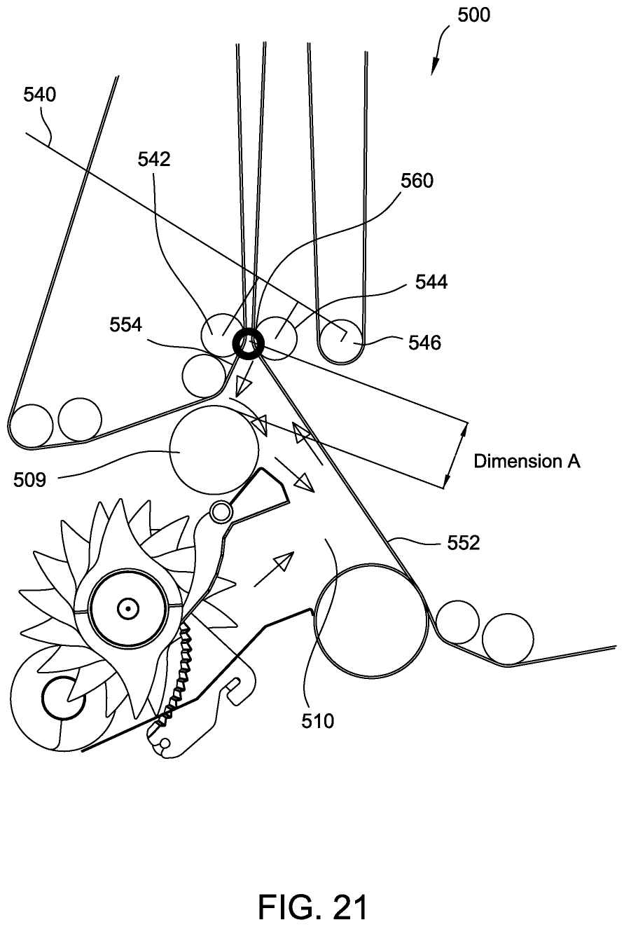

Crop material passes into the bale-forming chamber 510 through the crop inlet throat 506 that extends between the lower throat roller 508 and the upper throat roller 509. The variable-size bale forming chamber 510 is defined by the lower throat roller 508, bale forming belts 550, and the upper throat roller 509. The starting bale forming chamber is shown in FIGS. 20 and 21 (i.e., the chamber before addition of crop material). The belt 550 is routed around various rollers such that the starting bale forming chamber is defined by a rear belt span 552 and a front belt span 554.

During operation, incoming crop material is propelled backwards toward chamber 510 by the crop feeding device 504 into contact with the lower throat roller 508 that is rotating clockwise and the rear belt span 552 that is moving upwards. The crop material is propelled upwards, by the rear belt span 552, towards the front belt span 554. The crop material is forced to change direction at a belt convergence point 560, where the two belt spans 552, 554 are sufficiently close to one another (e.g., less than one inch apart) to cause the crop material to be re-directed downward. The crop material starts moving in a circular path to form a bale core within the chamber 510. The crop material follows the front belt span 554 downward and into contact with the upper throat roller 509 that is turning clockwise. The upper throat roller 509 redirects the crop material so that the material remains in the bale forming chamber 510 to continue the circular motion in the chamber.

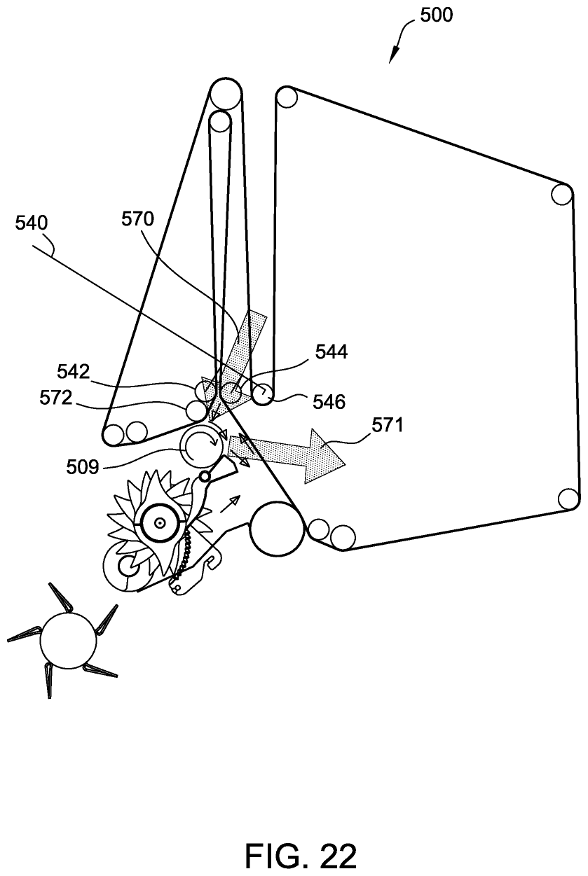

FIGS. 22-25 illustrate the bale growing in size including a variation in a first trajectory 570 of the crop material (and the belt) along the front belt span 554 toward the upper throat roller 509 (e.g., at the point where the belt 550 contact a front belt roller 572). A second trajectory 571 is defined in a direction generally directed towards the bale forming chamber 510. Trajectories 570 and 571 are substantially similar to trajectories 470 and 471 described above.

As crop material is fed into the bale forming chamber 510, the bale volume increases, resulting in additional length of belt 550 that contacts the outer periphery of the bale 501. The length of belt at the periphery of the bale 501 is available as a result of movement of a belt tightener 540, including rollers 542, 544, 546. As the belt tightener 540 rotates, the spans of belt between the rollers mounted to the belt tightener 540, and the other rollers mounted to the baler, change in length. These belt span lengths get smaller to provide the length of belt at the perimeter of the forming bale. The roller 542 that is mounted to the belt tightener 540 defines the direction of the belt trajectory 570. Similar to above-described trajectory 470, trajectory 570 is directed in a downward direction in order to prevent trajectory 570 from being aimed towards the gap between front belt roller 572 and upper throat roller 509, thereby preventing undesirable discharge of stray crop material from baler 500. Rather, crop material is directed back towards the bale forming chamber 510 along trajectory 571 by the clockwise rotation of the upper throat roller 509. The belt tightener 540, with the roller 542, is positioned such that as the belt tightener rotates, the roller 542 moves along a path that maintains approximately the same trajectory 570 regardless of the size of the bale.

FIG. 22 illustrates the trajectory 570 at the bale start, where it is directed towards the upper throat roller 509. As shown in FIGS. 22-25, the trajectory 570 (of the belt and crop material) is directed towards the upper throat roller 509 at all times, regardless of the bale size (i.e., a line coincident with the trajectory 570 intercepts the upper throat roller 509). By directing material to the upper throat roller 509 throughout bale formation, the potential for crop material to escape the bale formation chamber is reduced or even prevented, as any material following the trajectory 570 will contact the upper throat roller 509 which will deflect that material toward the bale chamber 510 and away from the crop inlet throat 506.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

1-20. (canceled)

21. A round baler comprising:
a crop feeding device;
a lower throat roller;
an upper throat roller;
an arrangement of rollers comprising at least a front belt roller;
one or more bale forming belts comprising:
a first belt span that moves in a first direction to lift crop material away from the lower throat roller; and
a second belt span that moves in a second direction essentially opposite of the first direction and having a trajectory; and,
wherein the crop feeding device directs crop material to the lower throat roller;
wherein the one or more bale forming belts are routed around the arrangement of rollers; and,
wherein the arrangement of rollers are configured to prevent the trajectory from being aimed toward a gap between the front belt roller and the upper throat roller throughout formation of a bale.

22. The round baler of claim 21, wherein the first belt span, the second belt span, the upper throat roller, and the lower throat roller form a bale forming chamber.

23. The round baler of claim 22, wherein the trajectory is a first trajectory, the first trajectory directing crop material toward a portion of the upper throat roller facing the bale forming chamber throughout formation of the bale, and wherein a second trajectory directs crop material from the upper throat roller toward the bale forming chamber.

24. The round baler of claim 22, wherein the arrangement of rollers comprises a belt tightening roller, the second belt span extending between the belt tightening roller and the front belt roller.

25. The round baler of claim 23, wherein the first trajectory is essentially directed downward.

26. The round baler of claim 22, wherein the bale forming chamber increases in size as more crop material enters.

27. The round baler of claim 22, wherein a belt tightener having rollers moves as the bale forming chamber changes size.

28. The round baler of claim 27, wherein the belt tightener motion is arcuate.

29. The round baler of claim 27, wherein the movement of the belt tightener changes the length of the first belt span and the second belt span.

30. The round baler of claim 27, wherein the movement of the belt tightener changes the angle of the second belt span.

31. The round baler of claim 27, wherein the round baler further includes a second belt tightener, one belt tightener being located in a front half of the round baler and the second belt tightener being located in a rear half of the round baler.

32. The round baler of claim 21, wherein the first belt span and the second belt span create a belt convergence point where the crop material is caused to change directions.

33. The round baler of claim 32, wherein the belt convergence point is formed by a belt path through belt rollers on a belt tightener.

34. The round baler of claim 33, wherein the first belt span, the second belt span, the upper throat roller, and the lower throat roller form a bale forming chamber, the belt convergence point moving from a minimum distance from the upper throat roller when no crop material is present in the bale forming chamber to a maximum distance from the upper throat roller when a full sized bale of material is present.

35. A baling system for baling crop material, the baling system comprising:
a crop feeding device;
one or more bale forming belts routed around and supported by various belt rollers, the bale forming belts comprising:
a first belt span that moves in a first direction to lift a crop material away from a lower throat roller; and
a second belt span that moves in a second direction essentially opposite of the first direction, the first belt span and the second belt span creating a belt convergence point;
a bale forming chamber defined in part by the one or more bale forming belts, the lower throat roller, and an upper throat roller;
wherein the crop feeding device directs the crop material to the lower throat roller;
wherein a distance between the upper throat roller and the belt convergence point is less than 15 inches when no crop material is present in the bale forming chamber;
wherein a first trajectory directs the crop material toward a portion of the upper throat roller facing the bale forming chamber throughout the formation of the bale; and
wherein a second trajectory directs crop material from the upper throat roller toward the bale forming chamber.

36. The baling system of claim 35, wherein the first trajectory is essentially directed downward.

37. The baling system of claim 35, wherein the belt convergence point is formed by a belt path through belt rollers on a belt tightener.

38. The baling system of claim 35, wherein the distance is a minimum distance, the belt convergence point moving from the minimum distance to a maximum distance from the upper throat roller when a full sized bale of material is present.

39. The baling system of claim 35, wherein a belt tightener having belt rollers moves as the bale forming chamber changes size.

40. The baling system of claim 39, wherein the movement of the belt tightener changes the length and angle of the first belt span and the second belt span.

41. A method for baling crop material comprising:
moving crop material through a crop inlet throat to a bale forming chamber, the crop inlet throat being defined between a lower throat roller and an upper throat roller;
rotating one or more belt drive rollers to move one or more bale forming belts to form a bale in the bale forming chamber, wherein motion of the one or more bale forming belts causes:
a first belt span to move in a first direction wherein crop material is lifted away from the lower throat roller; and
a second belt span to move in a second direction essentially opposite of the first direction;
wherein the first span, second span, upper throat roller, and lower throat roller form the bale forming chamber;
wherein the first belt span and second belt span define a belt convergence point where the crop material changes direction;
wherein the bale forming chamber increases in size during bale formation; and
wherein the second belt span has a trajectory that is not aimed toward a gap between a front belt roller and the upper throat roller during bale formation.
